(19) United States
(12) Patent Application Publication
(10) Pub. No.: US 2006/0159274 A1
(43) Pub. Date: Jul. 20, 2006

(54) Apparatus, method and program utilyzing sound-image localization for distributing audio secret information

(75) Inventors: Hiroki Shizuya, Sendai City (JP); Masahiro Mambo, Sendai City (JP)

Correspondence Address: OLIFF & BERRIDGE, PLC, P.O. BOX 19928, ALEXANDRIA, VA, 22320, US

(73) Assignee: TOHOKU UNIVERSITY, Sendai City (JP)

(21) Appl. No.: 10/761,228

(22) Filed: Jan. 22, 2004

(30) Foreign Application Priority Data
Jul. 25, 2003 (JP) 2003-202004

(51) Int. Cl. H04R 5/00

(52) U.S. Cl. 381/1; 381/56

(57) ABSTRACT

An apparatus utilizing sound-image localization for distributing/sharing audio secret information is provided, the apparatus comprises: a first signal processor for distributing/sharing at lest one target sound as secret information into a plurality of stereo media, wherein the distribution is performed such that the sound-image of the target is shifted from the center position of the head when said plurality of stereo media are simultaneously played to be heard in a binaural manner; a second signal processor for distributing a plurality of decoy sounds as disturbing information into the said plurality of stereo media, wherein the distribution is performed such that the sound-image of the decoy sounds is localized to the center position of the head when said plurality of stereo media are simultaneously played to be heard in a binaural manner.

### BACKGROUND OF THE INVENTION

1. Field of the Invention

The present invention relates to an apparatus, method and program utilizing sound-image localization for distributing/sharing audio secret information.

2. Related Art Statements

To implement the safety and flexibility management of secret information and the protection risk management of intellectual properties, secret information distributing (i.e., sharing) techniques for distributing digital information into several pieces of the information to share and manage them were researched (refer to documents: Adi Shamir, “How to share a secret,” Communications of the ACM, Vol. 22, No. 11, pp. 612-613, 1979, Markus Stadler, “Publicly Verifiable Secret Sharing,” EUROCRYPT'96, Lecture Notes in Computer Science 1070, pp. 190-199, 1996, and Wakaha Ogata, “On the Practical Secret Sharing Scheme,” IEICE Trans. Fundamentals, Vol. E84-A, No. 1, pp. 256-261, 1999). Recently, visual secret information sharing/distributing techniques (i.e., methods for sharing/distributing visual data) have been researched (refer to documents: Moni Naor, Adi Shamir, “Visual Cryptography,” EUROCRYPT'94, Lecture Notes in Computer Science 950, pp. 1-12, 1994, and Hiroki Koga “A General Formula of the (t,n) Threshold Visual Secret Sharing Scheme,” ASIACRYPT2002, Lecture Notes in Computer Science 2510, pp. 328-345, 2002). In this context, apparatus using visual properties for distributing/sharing visual secret and for decoding the distributed pieces of visual secret into the original visual secret without need of a special device has been developed. This approach is a technique sharing secret such that, for example, by superimposing two images, each of which is not recognized that what (i.e., the secret) is presented therein, into one meaningful image, which is recognized that what (i.e., the secret) is presented therein.

As with the visual secret sharing techniques, audio secret distributing/sharing techniques without need of special device for decoding the distributed/shared information has been proposed. There is only one practical technique among them, it is the “Nonbinary Audio Cryptography” (refer to a document: Yvo Desmedt, Tri Van Le, Jean-Jacques Quisquater, “Nonbinary Audio Cryptography,” Information Hiding'99, Lecture Notes in Computer Science 1768, pp. 478-489, 1999). However, this conventional technique requires for complicated signal processing to generate pieces of information to be distributed (such as the Discrete Fourier Transform) and thus this technique is not convenient. If how to eliminate the complicated processing can be devised, it is useful for organizations, which distribute a great number of sound information, such as companies of music industry.

In addition, a certain type of digital watermark, unlike secret sharing techniques, as information security system using auditory properties has been proposed (refer to a Japanese document: Atsuki Tomiokaet, Takao Nakamura, Yohichi Takashima, “Digital Watermark to Multi-channel Digital Audio,” IEICE, 1998). This conventional approach is a technique for embedding watermark into localization information of multi-audio channels. In the case of stereo two channels, for instance, although sound source localization is determined based on balance of right and left sound pressures, data (i.e., watermark) can be embedded by changing the balance of the sound pressures. In the stereo, although sound source position is localized to the midpoint, on the average, of two speakers, in a moment of time the sound source position is shifted to left and right from the midpoint. In this technique, watermark (such as 0 or 1) is represented by shifting original localization positions of the original sound signals to left or right position. In order to extract the embedded data (i.e., watermark), the original signals are required. However, this technique is not a secret sharing method for distributing/embedding secret into several media to share them, if once the embedding method is known, it has disadvantages that the embedded digital watermark information is broken down.

### SUMMARY OF THE INVENTION

As mentioned above, in the conventional audio secret information sharing techniques, the techniques require for complicated process of sound signals and thus they are not convenient and not cost effective. Consequently, it is an objective of the present invention to provide an apparatus, method and program utilizing sound-image localization without need of complicated signal process.

In order to solve the above mentioned problems, an apparatus (i.e., device) utilizing sound-image localization for distributing/sharing audio secret information is provided, the apparatus comprises:

a first signal processor for distributing/sharing at lest one target sound as secret information into a plurality of stereo media, wherein the distribution is performed such that the sound-image of the target is shifted from the center position of the head when said plurality of stereo media are simultaneously played to be heard in a binaural manner;

a second signal processor for distributing a plurality of decoy sounds as disturbing information into the said plurality of stereo media, wherein the distribution is performed such that the sound-image of the decoy sounds is localized to the center position of the head when said plurality of stereo media are simultaneously played to be heard in a binaural manner.

According to the present invention, secret information can easily be distributed/shared by simple process such that whether or not sound-image is shifted from the center position of the head and the distributed/shared secret information may be decoded using human audio properties. In other word, according to the invention, in both generating some pieces of information to be distributed from secret information and decoding the distributed/shared pieces into the original secret, signal processing may considerably be reduced. Also, it makes it possible to securely distribute/share secret information in which the shred pieces of the secret are considerably tolerant to collusion.

In an embodiment of the apparatus according to the present invention, said first and second signal processors control whether or not that the sound-image is localized to the center position of the head by adjusting volumes of right and left channels of the stereo media, respectively.

According to the present invention, the sound-image can easily be localized to either the center of the head or the non-center of it by simple process of adjusting respective volumes of right and left channels of the stereo media.

In another embodiment of the apparatus according to the present invention, the apparatus further comprises:

calculating means for calculating the number of said stereo media from a desired safety factor (i.e., upper limit/threshold, which is a distribution formation whether or not that the target and decoy sound can be identified) and/or an anticipated colluder factor (i.e., collusion ratio) using a predetermined equation; and

control means (option) for controlling said first and second signal processors to allow them to distribute/share the secret information using the calculated number of the stereo media by the said calculating means.

According to the present invention, by inputting the safety factor, which is acceptable by a user, or predicted colluder factor, it is easy to set the number of media which meets this condition i.e. the factors. Accordingly, it is assured that the desired safety ratio is certainly kept by inputting the factors to set up the number of the media.

By way of easy explanation the aspect of the present invention has been mainly described as the apparatus, however it is understood that the present invention may be realized as methods corresponding to the apparatus, programs embodying the methods as well as a storage media storing the programs therein.

For example, according to another aspect of the present invention, a method utilizing sound-image localization for distributing audio secret information is provided, the method comprises the steps of:

a first step for distributing at lest one target sound as secret information into a plurality of stereo media, wherein the distribution is performed such that the sound-image of the target is shifted from the center position of the head when said plurality of stereo media are simultaneously played back to be heard in a binaural manner;

a second step for distributing a plurality of decoy sounds as disturbing information into the said plurality of stereo media, wherein the distribution is performed such that the sound-image of the decoy sounds is localized to the center position of the head when said plurality of stereo media are simultaneously played to be heard in a binaural manner.

In an embodiment of the method according to the present invention, said first and second steps control whether or not that the sound-image is localized to the center position of the head by adjusting volumes of right and left channels of the stereo media, respectively.

In another embodiment of the method according to the present invention, the method further comprises:

calculating the number of said stereo media from a desired safety factor (i.e., upper threshold, which is a distribution formation whether or not that the target and decoy sound can be identified) and/or an anticipated colluder factor using both a predetermined equation and computing means; and

controlling (option) said first and second signal processors to allow them to distribute/share the secret information using the calculated number of the stereo media by the said calculating step.

In addition, according to another aspect of the present invention, a program for executing a method utilizing sound-image localization for distributing audio secret information is provided, said program comprises the steps of:

a first step for distributing at lest one target sound as secret information into a plurality of stereo media, wherein the distribution is performed such that the sound-image of the target is shifted from the center position of the head when said plurality of stereo media are simultaneously played back to be heard in a binaural manner;

a second step for distributing a plurality of decoy sounds as disturbing information into the said plurality of stereo media, wherein the distribution is performed such that the sound-image of the decoy sounds is localized to the center position of the head when said plurality of stereo media are simultaneously played to be heard in a binaural manner.

In an embodiment of the program according to the present invention, said first and second steps control whether or not that the sound-image is localized to the center position of the head by adjusting volumes of right and left channels of the stereo media, respectively.

In another embodiment of the program according to the present invention, the program further comprises:

calculating the number of said stereo media from a desired safety factor and/or an anticipated colluder factor using both a predetermined equation and computing means; and

controlling (option) said first and second signal processors to allow them to distribute/share the secret information using the calculated number of the stereo media by the said calculating step.

In still another embodiment of the apparatus, method and program according to the present invention,

the sum, n (i.e., the number of the total sound), of the number of said target sound and the number of said decoy sounds is equal to or less than 6 (n≦6), or

the peak amplitude, p, of one side (i.e., left or right channel) of one sound signal of said stereo media is equal to or less than about 10 (p≦about 10).

### BRIEF DESCRIPTION OF THE DRAWINGS

Exemplary embodiments of the present invention will now be described in detail with reference to the accompanying drawings in which:

FIG. 1 is a block diagram showing a basic configuration of an exemplary embodiment of an audio secret distributing/sharing apparatus according to the present invention;

FIG. 2 is a graph illustrating relationship between q and E, when the number of colluder k (those who collude with each other) is fixed to 100 (i.e., k=100);

FIG. 3 is a graph depicting relationship between q and e, when the number of colluder k (those who collude with each other) is fixed to 1000 (i.e., k=1000); and

FIG. 4 is graphs representing, respectively, relationship between k and ε when the number of colluder k is fixed to 100 (i.e., k=100), relationship between k and ε when the number of colluder k is fixed to 1000 (i.e., k=1000), and relationships between k and q/k when ε is fixed to 10⁻³ and 10⁻¹⁰ (ε=10⁻³ and ε=10⁻¹⁰).

### DETAILED DESCRIPTION OF THE PREFERRED EMBODIMENTS

Several preferred exemplary embodiments and principles of the present invention will be described with reference to the accompanying drawings.

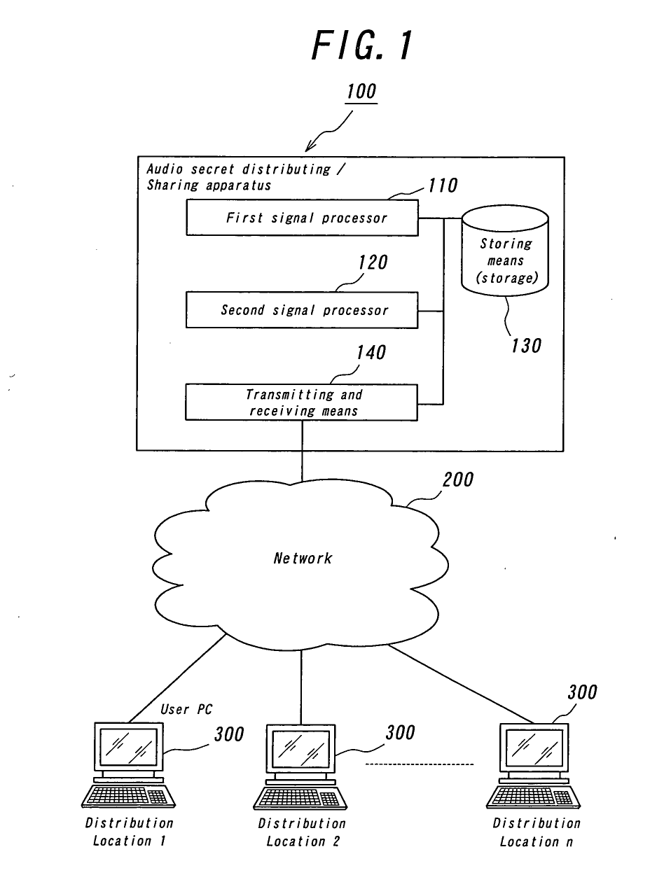

FIG. 1 is a block diagram showing a basic configuration of an exemplary embodiment of audio secret distributing/sharing apparatus according to the present invention. As shown in FIG. 1, audio secret distributing/sharing apparatus 100 of the present invention includes a first signal processor 110 (e.g., a first signal processing circuit), a second signal processor 120 (e.g., a second signal processing circuit), storing means 130 (e.g., storage), and transmitting and receiving means 140 (i.e., communicating means). The first signal processor 110 distributes at least one target sound as secret information into a plurality of stereo media and the distribution is performed such that the sound-image of the target is shifted from the center position (i.e., the image is localized to the left or right not to the center) of the head when said plurality of stereo media, which are distributed/embedded any pieces of the secret, are simultaneously played to be heard in a binaural manner. The second signal processor 120 distributes a plurality of decoy sounds as disturbing information into the said plurality of stereo media and the distribution is performed such that the sound-image of the decoy sounds is localized to the center position of the head when said plurality of stereo media are simultaneously played back to be heard in a binaural manner. In this way the prepared plurality of media are temporarily stored in the storing means 130 (such as a storage or a hard disc). Then, the stereo media (which are audio files and it is preferable that which are compressed before transmission) are transmitted to user PCs or servers at distribution locations 300 via network 200 (such as the Internet) and they would separately be stored in the user PCs at the plurality of the separated locations 300, the number of which are same as that of the medias, respectively. After transmitting the audio files, the information regarding the secret (such as the original secret and the files, etc.) stored in the storage 130 is eliminated. When desiring to restore the secret information, the apparatus 100 prompts the user PCs at all the distribution locations 300 to transmit the all distributed stereo media. Then the apparatus receives the all stereo media from the PCs and the received stereo media is simultaneously played. When a human being hears/listens the played back the sounds i.e., all stereo media, the person can identify “the at least one target sound as a secret” from the several sounds by detecting “the shift of the sound-image” with human auditory properties/abilities. In addition, the present apparatus further comprises a CPU (not shown) for calculating and producing control signals for allowing respective signal processors to perform processes with distribution algorithm as described later), calculation means (not shown) for calculating the number of stereo media from a desired safety factor and/or an anticipated colluder ratio, and control means (not shown) for controlling the first and second signal processors to allow them to distribute the media using the calculated the number of media in the calculation means.

In addition, although it is preferable that the target sound as secret information, several target sounds can be distributed such that one target sound is localized to the “right” position of the head and other target sound is localized to the “left” position of that. In the present invention, because target sound(s) can be distinguished from the several decoy sounds, it can be configured that, for example, the sound-image of the target sound is localized to the right side of the head and the sound-images of the remaining i.e., decoy sounds are localized left side of the head, for further example, only the target sound-image is localized to the center and the remaining sound-images (i.e., decoy sounds) are localized to the right or left of the head.

Sense of Direction

The present invention employs human abilities of “sense of direction”. A human being can easily recognize the direction of a sound source even if he/she hears the sound with eyes shut. Almost every man can recognize from where the sound is coming day-to-day situation but if the hearer/listener is in a particular sound environment such that reflection sounds frequently take place. The above mentioned direction sense of the sound source is performed based on both a difference of arrival times and a difference of strengths of a sound wave between left and right ears (refer to a Japanese document: Hisao Sakai and Takeshi Nakayama, “Auditory Perception and Auditory Psychology,” Japan Audio Engineering Society, CORONA Publishing, 1978). Accordingly, when the difference of the arrival times is eliminated with binaural hearing using a headphone, human audio perception performs the direction sense based upon only the strength difference (i.e., a difference of left and right sound volumes) of the sound. It is known that in the binaural hearing, when a human hears a sound that a right sound volume is the same as the left one, sound-image of the sound is localized to the center of the head. It is also known that when there is a volume difference (i.e., one of the left and right sound volume is higher than other), sound-image of the sound is shifted from the center to one side, having the higher sound volume, of the head. In addition it is known that a threshold value, whether or not that sound-image is shifted from the center to left or right side, is about 2 dB, which is a difference between left and right sound pressure level (SPL), and almost human being can easily perceive the leaning of the sound-image without any difficulty when there is an SPL difference being equal to or more than about 2 dB.

Although in the present invention sound-image shifting from the center of the head is controlled, there are several kinds of techniques for controlling the sound-image shift. One of the control techniques using an opposite phase sound will be described and its characteristics are as follows.

Characteristic 1 (Opposite Phase Sound)

In monaural or one channel of stereo, when a positive sound (i.e., original sound) is superposed or mixed with its opposite phase sound, the mixed sounds become silent.

When a stereo media, in which one channel having positive phase sound and other channel having its inverted phase sound are recorded therein, is heard, the sound becomes fuzzy and different from the original sound.

In monaural and stereo, whichever positive or inverted phase sound is heard, a human being perceives them as the same sound.

The present invention is a technique for distributing/sharing sound secret, wherein the secret is that “which is a target sound signal among a plurality sound signals?”. More specifically, in the present technique, for example one target sound is brought into under cover of n−1 decoy sounds as disturbing information and all of the sounds including both the target and decoy are distributed k pieces of media. Then the k pieces of media are played back simultaneously and the one target sound is identified from n sound signals. Since this scheme does not need to make a secret of contents in itself of sound signals, it is no matter that respective contents of the sounds are heard just as it is and thus it is no problem that listener may recognize respective contents of the sound signals. In this scheme, the distributing media are configured such that, when the k pieces of media are combined, n−1 decoy sounds are localized to the center of the head and one target sound is shifted to either right or left of the head from the center of the head. In this manner the secret “which is a target sound among the several sounds?” can be identified.

According to the present technique, due to extremely simple process that respective volumes (i.e., left and right volumes) of each sound are adjusted respectively, cost and computing power of the distribution process are advantageously reduced.

In addition, it is preferable that stereo media capable of recording in left and right channels is used as the distributing media, because sound-image localization position in the head is determined based upon the difference between the left volume and right volume.

Distributing Rule for Each Sound Signal

Assuming that there is “n” kinds of sound signals and one of the sound signals is located/distributed to 5 pieces of stereo media (No. 1-5), a distribution example of it is as following table.

TABLE 1

| | L | R |
|---|---|---|
| No. 1 | 5 | −2 |
| No. 2 | −4 | −6 |
| No. 3 | −2 | 10 |
| No. 4 | 8 | −3 |
| No. 5 | −7 | −2 |
| Total | 0 | 1 |

In this table, plus sign (+) represents a positive phase and minus sign (−) represents an inverted phase, and then numeric character represents number of times (amplitude or sound volume) of superimposing of sound signal. In addition, L and R mean a left side/channel and right side/channel of the stereo sound, respectively. In this example, No. 3 comprises a left channel having a sound such that left side sound phase of the original sound is inverted and the inverted sound is superimposed twice. When the 5 pieces of media are combined (i.e., are simultaneously played back), total left channel sound is zero (i.e., silent) and total right channel sound is +1 (i.e., only right channel can be heard by listener) as shown in total column. Accordingly, since this sound signal image is not localized to the center of the head, this sound signal is not the target sound.

Generation Rules for a Target Sound(s)

Assuming that one sound is distributed/located to k pieces of media as following table.

TABLE 2

| | L | R |
|---|---|---|
| No. 1 | l₁ | r₁ |
| No. 2 | l₂ | r₂ |
| . | . | . |
| . | . | . |
| . | . | . |
| No. k − 1 | lₖ₋₁ | rₖ₋₁ |
| No. k | lₖ | rₖ |

In order to set this one sound up as a target sound, a following equation must be satisfied.

$$( {\sum }_{i = 1}^{k} {l}_{i} , {\sum }_{i = 1}^{k} {r}_{i} ) = ( 0 , 1 ) or ( 1 , 0 ) or ( 0 , - 1 ) or ( - 1 , 0 ) \qquad ( 1 )$$

Generation Rules for Decoy Sounds

In the same situation, in order to set this one sound up as a decoy sound, following equation must be satisfied.

$$( {\sum }_{i = 1}^{k} {l}_{i} , {\sum }_{i = 1}^{k} {r}_{i} ) = ( 0 , 0 ) or ( 1 , 1 ) or ( - 1 , - 1 ) \qquad ( 2 )$$

Here, in the generation rules for decoy sounds, (+1, −1) and (−1, +1) are not adopted. Because when such sounds having same amplitude in both right and left channels and the respective phases are opposite each other are heard in a binaural manner, the sound-image is not localized to any position in the head and thus is recognized as a fuzzy sound. According to both the target generation rules and decoy generation rules, amplitudes of respective sides (i.e., each of left and right channel) are must be either 0 or 1, when k pieces of media are simultaneously played back. In addition, for each sound signal, it is preferable that an amplitude being recorded in one channel of one media is within a predetermined upper limit. If p>0, lᵢ and rᵢ must satisfy following conditions.
∀i s.t.1≦i≦k, |li|≦p, |ri|≦p (3)

This threshold is prepared for avoiding a sound having amplitude value (1) from relatively excessive reducing when all media are played back.

Distribution and Location Algorithm

An exemplary distribution and location algorithm satisfying the above-mentioned conditions will be described hereinafter. Outline of operations in this algorithm is as follows. In order to randomly select right and left values of i-th media, sets Pₗ and Pᵣ are prepared for being selected therefrom. The sets Pₗ and Pᵣ are updated every time in which value of i is increased within a range of (1<i<k−1).

Absolute values of elements in the sets Pₗ and Pᵣ are equal to or less than p (i.e., the upper limit of an amplitude) and sets Pₗ and Pᵣ of i-th are determined based upon Sum(l), which is calculated from Sum(l)=l₁+l₂ . . . +lᵢ₋₁, and Sum(r). which is calculated from Sum(r)=r₁+r₂. . . +rᵢ₋₁. In addition, absolute values of sum of Sum(l) and lᵢ and sum of Sum(r) and rᵢ are limited to a range not more than the upper limit p.

Next, lᵢ and rᵢ are randomly and uniformly selected from the prepared sets Pₗ and Pᵣ, respectively. This process, as well as updating the Pₗ and Pᵣ, is performed to all i values within a range of (1<i<k−1).

Finally, when i=k, the sets Pₗ and Pᵣ are updated for allowing lₖ and rₖ to satisfy simultaneously above three equations (1)-(3).

The above-described scenario is for only one sound signal, in practical the-present distribution algorithm can distribute/share secret information by repeating this scenario for n kinds of sound signals.

Distribution and Location Algorithm for Respective Sound Signals

1 Input (p, k)
2 Sum(l)=Sum(r)=0;
3 For (i=1, . . . , k−1)
4 P₁={x∥Sum(l)+x|<p, |x|<p}
5 P1={x∥Sum(r)+x∥<p, |x|<p}
6 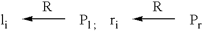
7 Sum(l)←Sum(l)+1ᵢ; Sum(r)←Sum(r)+rᵢ
8 End For
9 If {sound signal is a target sound}
10 Then determine lₖ and rₖ to meet equation (1)
11 Else determine lₖ and rₖ to meet equation (2)
12 End If
13 Output (l₁, . . . , lₖ, r₁, . . . , rₖ)

When Sum(l)=a>0, values of P₁ will be P₁={−p, . . . , p-a} in step 4. Here, one element for lᵢ would randomly be selected from the set P₁ including (2p+1−a) elements in step 6. Hereinafter, a user corresponding to media No. k in which lₖ and rₖ are recorded is referred to as “final distributed person”.

Restoration of Secret Information

By means of the above mentioned distribution algorithm, there are lₖ and rₖ which satisfy equations (1) and (2) for arbitrary (l₁, . . . , lₖ₋₁, . . . , r₁, . . . , rₖ₋₁). Any sound signal can be either a target sound or a decoy sound by adjusting are lₖ and rₖ. Because according to this algorithm following equations are satisfied.

$$\vert {\sum }_{i = 1}^{k - 1} {l}_{i} \vert \leq p , \vert {\sum }_{i = 1}^{k - 1} {r}_{i} \vert = \text{≤} p$$

or
|lₖ|≦p,|rₖ|≦p

In regard to a left side/channel of a media,
If

$${\sum }_{i = 1}^{k} {l}_{1} = \pm p , \qquad {\sum }_{i = 1}^{k} {l}_{i}$$

is either 0, or ±1 (where double signs correspond to respective values of the former equation in the same order).

If

$${\sum }_{i = 1}^{k} {l}_{1} \neq \pm p , \qquad {\sum }_{i = 1}^{k} {l}_{i}$$

is either 0, or 1−1.

The same applies to right side/channel of a media. Thus there exist lₖ and rₖ which satisfy both equations (1) and (2).

Accordingly, when this algorithm is applied to one sound signal as a target sound of n kinds of sound signals, the target sound (i.e., the secret) is distributed to several media. Since the secret is distributed to respective media, even if each media is independently played back, several sounds having different volumes respectively are played back and thus hearer cannot identify the target sound from the several sounds recorded in the distributed media.

Security

In order to discuss security or safety, ability of user and safety are defined as follows.

Definition 1 (About User)

Abilities of user are defined as follows:

User can hear one or more media, which are simultaneously played back.

User can analyze and amplify the media by a computer.

User cannot to prepare a new medium to provide it as a distributed medium.

User knows an upper limit p, number k of all media, and number n of kinds of sound signals.

User can analyze media to obtain the number of superimposing times in each sound signal in each channel (right and left side) recorded in the media.

Attack of collusion is restricted to only one technique for distinguish between a target sound and a decoy sound based upon the number of superimposing which is obtained by analyzing.

Now, it is assumed that several users actually collude with each other. Each of the plurality of media includes a plurality of sound signals and the attackers or those who collude (i.e., colluders) may analyze the plurality of sounds in the media to obtain the number of superimposing times of each sound signal. In this example, it is favorable to the colluders because in practical sense, colluders often cannot identify the number of superimposing times because it takes long time to analyze them.

The safety of the present secret distribution technique according to the invention is assured on the condition that it is not identified whether each of the sound signals, which are distributed with the use of the above-mentioned algorithm, is a target or decoy sound. Accordingly it will be explained below about a certain one sound signal.

Collusion Without the Final Distributed Person

Even if (k−1) users (i.e., who are other than the final distributed person) are in collusion with each other, following conditions are satisfied.

$$\vert {\sum }_{i = 1}^{k - 1} {l}_{i} \vert \leq p , \vert {\sum }_{i = 1}^{k - 1} {r}_{i} \vert = \text{≤} p$$

According to the conditions, the certain one sound signal may be either a target sound or a decoy sound by the media distributed to the final distribution person. Therefore, the colluders cannot identify whether the sound is a target or it is a decoy. Accordingly, assuming that the final person is trusty, if several users act in collusion with each other in the present distribution technique according to the invention, information regarding to identification of the target and decoy could not be leaked out.

Collusion with the Final Distributed Person

In a collusion involving the final distributed person unlike the above mentioned collusion without the final person, it is not improbable that it is not assured that the sound signal which is analyzed by colluders can be both a target or decoy depending on information of user(s) who does not involve the collusion. In order to confirm this a lemma is provided as follows:

Lemma 1

Supposing that sound signal is identified whether the signal is a target or decoy, every users not anticipating a collusion have same media and every absolute values (i.e., amplitudes) of the number of superimposing times of respective sides (left and right) must be an upper limit p.

Proof

As described above, the colluders not including the final distributed person cannot identify whether the sound is a target or it is a decoy. And now, it is assumed that number of colluders including the final distributed person is (k−m) and number of users who did not involve a collusion is m and distributed media of that m persons are No. J₁, . . . No. jₘ.

Letting j_{U}ε{jᵢ, . . . , jₘ}, according to equation (3) following conditions are satisfied.

$$\vert {\sum }_{u = 1}^{m} {l}_{ju} \vert \leq mp , \vert {\sum }_{u = 1}^{m} {r}_{ju} \vert = \text{≤} mp$$

Here, since colluders knows values of

$${\sum }_{i = 1 , i \neq ju}^{k} {l}_{i} ,$$

values of

$${\sum }_{i = 1}^{k} {l}_{i}$$

corresponding to each value of

$${\sum }_{i = 1 , i \neq ju}^{k} {l}_{i}$$

are categorized into several groups as listed in a following table and the same applies to rᵢ.

TABLE 3

| ${\sum }_{i = 1 , i \neq ju}^{k} {l}_{i}$ | ${\sum }_{i = 1}^{k} {l}_{i}$ |
|---|---|
| mp + 1 | +1 |
| mp | 0, +1 |
| mp − 1 | −1, 0, +1 |
| . | |
| . | |
| . | |
| −mp + 1 | |
| −mp | −1, 0 |
| −mp − 1 | −1 |

Values of

$$( {\sum }_{i = 1}^{k} {l}_{i} , {\sum }_{i = 1}^{k} {r}_{i} )$$

can be only either (0, ±1), (±1, 0), (0, 0), or (×1, ×1). Accordingly, when values of

$$( {\sum }_{i = 1 , i \neq {j}_{u}}^{k} {l}_{i} , {\sum }_{i = 1 , i \neq {j}_{u}}^{k} {r}_{i} ) ,$$

which are obtained based upon the distributed information which are provided by the colluders, are provided, there exist a case where the sound is identified whether the sound is a target or a decoy sound. The case includes only 6 patterns as shown in a following table.

TABLE 4
(vulnerably combination for collusion)

| ${\sum }_{i = 1 , i \neq ju}^{k} {l}_{i} , {\sum }_{i = 1 , i \neq ju}^{k} {r}_{i}$ | $( {\sum }_{i = 1}^{k} {l}_{i} , {\sum }_{i = 1}^{k} {r}_{i} )$ | (lⱼ_{ᵤ}, rⱼ_{ᵤ}) |
|---|---|---|
| −mp, mp + 1 | (0, +1) | (+p, −p) |
| mp + 1, −mp | (+1, 0) | (−p, +p) |
| mp, −mp − 1 | (0, −1) | (−p, +p) |
| −mp − 1, mp | (−1, 0) | (+p, −p) |
| mp + 1, mp + 1 | (+1, +1) | (−p, −p) |
| −mp − 1, −mp − 1 | (−1, −1) | (+p, +p) |

Accordingly, when the sound is identified whether it is decoy or not, m users not involving a collusion will always have the same media, which is any one of pairs as follows:

$$\begin{matrix}( {l}_{{j}_{1}} , {r}_{{j}_{1}} ) = ⋯ \\ = ( {l}_{{j}_{m}} , {r}_{{j}_{m}} ) \\ = ( + p , + p ) or ( - p , - p )\end{matrix}$$

or (+p,−p) or (−p,+p)

However, even in a case that the above condition is satisfied, the sound cannot be identified but if the combination in the table 4 is satisfied.

However, if m users have same media, which is weak for collusion, there exist a case that remaining k-m users (i.e., who are other than m users) may act in collusion with each other to distinguish a sound between a decoy and target.

### EXAMPLE 1

### Case that a Sound is Identified as a Target by k−m Colluder

A combination, as an example, in a second row from the top of the table will be explained. In the second row, a following combination is listed.

$$( {\sum }_{i = 1 , i \neq {j}_{u}}^{k} {l}_{i} , {\sum }_{i = 1 , i \neq {j}_{u}}^{k} {r}_{i} ) = ( + 1 , 0 )$$

(lⱼ₁, rⱼ₁)=(lⱼ₂,rⱼ₂)=(−p,+p).

In this example, a situation is discussed, in which the case is that (k−2) users other than two persons having media No. j₁ and No. j₂ act in collusion among them. Sums of theirs distributed information are obtained by the colluders as:

$${\sum }_{i = 1 , i \neq {j}_{u}}^{k} {l}_{i} = 1 + 2 p$$

$${\sum }_{i = 1 , i \neq {j}_{u}}^{k} {r}_{i} = - 2 p$$

According to both these values and the table 3, possible values of a combination of the left and right sounds are obtained as follows:

$${\sum }_{i = 1}^{k} {l}_{i} = + 1 , \qquad {\sum }_{i = 1}^{k} {r}_{i} = 0 , \qquad - 1$$

The colluders then obtain a following pair based upon the possible values of the combination of the left and right sounds, equations (1), and (2).

$$( {\sum }_{i = 1 , i \neq {j}_{u}}^{k} {l}_{i} , {\sum }_{i = 1 , i \neq {j}_{u}}^{k} {r}_{i} ) = ( + 1 , 0 )$$

Accordingly, the sound is identified as a target sound.

Theorem 1

When the sound secret information distribution is performed using the above described distribution algorithm, it is assumed that number of colluders is q. When q is within a range as follows:
q≦k/2−1 (i)
the colluders cannot distinguish any sound signals included in the media between a target sound and a decoy sound.

When q is within a range as follows:
k/2−1<q≦k−1 (ii)

A probability, p₁, that the colluders cannot distinguish any sound signals of n kinds of sound signals between a target and decoy sounds satisfy a following inequality.

$${P}_{1} > 1 - {\sum }_{i = k - q}^{k / 2} B ( i ; k , 1 / {p}^{2} )$$

where B(i;k,l,1/p²) denotes a binomial distribution of a following density function.

$${{}_{k}^{}{C}{}_{i}^{} ( \frac{1}{{p}^{2}} )}^{i} {( 1 - \frac{1}{{p}^{2}} )}^{k - i}$$

Proof

If a sound is identified as whether it is a target sound or a decoy sound by collusion, a following equation is certainly satisfied.
|lᵢ=|rᵢ|=p

Four media (+p, +p), (−p, −p), (+p, −p) and (−p, +p) comprising absolute (p) are referred as to “weak media (l_{w}, r_{w}) for collusion”.

When

$$( {l}_{i} , {r}_{i} ) \{ \begin{matrix}( {l}_{w} , {r}_{w} ) & i is an odd number \\ ( - {l}_{w} , - {r}_{w} ) & i is an even number\end{matrix}$$

a probability that there exist the weak media (l_{w}, r_{w}) is maximized. The maximum number of the weak media (l_{w}, r_{w}) is k/2.

It is assumed that
q≦k/2−1 (i)
if there are m weak media, the sound can be distinguished between a target sound and a decoy sound by (k−m) persons in collusion. When a head count of colluders is less than (k/2−1), the sound is not identified.

When q is within a range as follows:
k/2−1≦q≦k−1 (ii)
a probability that No. j media be a weak media (l_{w}, r_{w}) will be given below.

lᵢ is discussed without losing generality, the lᵢ is randomly selected form the set p₁, letting sum(l)=l₁+, . . . ,+lᵢ₋₁=a, following conditions are derived.

$$Pr [ \vert {l}_{i} \vert = p ] = \{ \begin{matrix}\frac{1}{2 p - a + 1} < \frac{1}{p} & ( a \neq 0 ) \\ \frac{2}{2 p + 1} < \frac{1}{p} & ( a = 0 ) .\end{matrix}$$

The similar relationships for rᵢ can be derived. In this manner, since left and right sides/channel are less than 1/p, independently, the probability that j-th media be the weak media (l_{w}, r_{w}) is given by

$$Pr [ \vert {l}_{j} \vert = \vert {r}_{j} \vert = p ] < \frac{1}{{p}^{2}}$$

Therefore, a probability, at the very most, that the weak media (l_{w}, r_{w}) is just I pieces of k pieces of media is as follows:

$${{}_{k}^{}{C}{}_{I}^{} ( \frac{1}{{p}^{2}} )}^{I} {( 1 - \frac{1}{{p}^{2}} )}^{k - I} = B ( I ; k , 1 / {p}^{2} ) .$$

A distribution probability, p₁, that distribution be performed such that a certain sound signal cannot be identified as either a target sound or a decoy sound by those who collude each other, satisfies a following inequality.

$${P}_{1} > 1 - {\sum }_{i = k - q}^{k / 2} B ( i ; k , 1 / {p}^{2} )$$

When secret is distributed into media having d channels (not exclusively for stereo media having two channels) in this scheme and number of colluder is q, a probability that a sound be identified as either a target sound or a decoy sound by collusion is expected as follows:

$${\sum }_{i = k - q}^{k / 2} B ( i ; k , c / {p}^{d} )$$

where k is number of those to which media are distributed, c is a constant, p is an upper limit, and d is number of channels.

Respective parameters involving this scheme will be explained below.

Setup of n

The n is number of kinds of sound signals. In the present invention, since secret information is “which is a target sound among n kinds of sound signals?”, the secret information is log ‘n’ bits. Accordingly, it is preferable that n is increased as much as possible because many pieces of secret can be distributed/shared in with a higher number of n. However, in the present invention, data restoration is achieved by playing back all media simultaneously. Thus, if n is so high, it is possible that the localization of sound-image is failed by excessive decoy sounds because the decoy sounds and target sound are heard all at once. In practical sense, a sound that sound-image is shifted from the center of the head can be distinguish form a sound that sound-images is localized to the center of the head if and only an electric power of the former sound is −10 dB lager than that of the latter sound. According to these characteristics, number, n, of kinds of sound signals (i.e., sum, n, of number of a target(s) and number of decoy sounds) are prepared.

An amplitude of target sound that sound-image is localized to either left or right during playing back all media simultaneously is 1 according to equation (1) and thus its electric power is also 1. In addition, for decoy sounds, amplitudes of that must be either silent or 1 (both left and right channels) according to equation (2). The worst case, in which amplitudes of the all sound signals are 1 both left and right sides of the signals, is discussed. In this condition, electrical powers of all decoy sounds (n−1 kinds of sound signals) in which sound-images are localized to the center of the head are 2(n−1). Therefore, in order to certainly shift sound-image of the target sound from the center position in the head, that is to localize it in which it is out of the center position, when all media are played back, following conditions must be satisfied.

$$10 {log}_{10} \frac{1}{2 ( n - 1 )} \geq - 10$$

$$2 ( n - 1 ) \leq 10$$

$$n \leq 6$$

In order to reliably identify a target sound even if n becomes larger, decoy sounds, in which each sound-image of the respective decoy is localized to the center and they likely complicate identification of the target sound, are eliminated (i.e., become silent) by “simultaneous play back”. For that purpose, the generation rules of decoy sounds is changed as follows:

$$( {\sum }_{i = 1}^{k} {l}_{i} , {\sum }_{i = 1}^{k} {r}_{i} ) = ( 0 , 0 )$$

Even if the generation rules of decoy sounds is changed as the above, secret distribution can successfully be achieved using the above-mentioned distribution algorithm by repeating n times for n kinds of sound signals, because the process of the algorithm must terminated per each sound signal. Tolerance of collusion in such case will be discussed below.

it is assumed that those who did not act in a collusion is m. It is also assumed that
m≦k/2−1

It is further assumed that distributed media of these m persons are No. Jₗ, . . . , No. jₘ, and j_{U}ε{jᵢ, . . . , jₘ}.

Although

$${\sum }_{i = 1}^{k} {l}_{i}$$

can be the same values as the tables, when a following equation:

$${\sum }_{i = 1 , I \neq {j}_{u}}^{k} {l}_{i} = mp + 1 , - mp - 1$$

is satisfied and thus the values can be only either +1 or −1 in this condition, in such a case the target sound can be identified by a collusion. Accordingly, when a value of one of left or right channel of a certain medium is the upper limit p the distribution is weak to a collusion and a probability that an amplitude of either left or right channel in a certain medium has a value of p which is the upper limit is given by

$$\begin{matrix}Pr [ \vert {l}_{i} \vert = p or \vert {r}_{i} \vert = p ] < \frac{2 p - 1}{{p}^{2}} \\ < \frac{1}{p}\end{matrix}$$

Accordingly, a probability that a sound signal is identified as a target sound signal by q(=k−m) persons who are in collision is obtained as

$${\sum }_{i = k - q}^{k / 2} B ( i ; k , 1 / p )$$

If the decoy generation rules are restricted to the above, there is no necessary to use stereo media and thus monaural media can be used because the rules do not exploit human auditory property capable of localizing a sound-image. The probability of identification in monaural media is obtained as the above described equation in which d is substituted by 1 (monaural channel) and thus the identification probability in monaural should be considerably high than that in stereo media.

Setup of p

The p is the maximum amplitude (i.e., the peak amplitude) of either left or right channel of one sound signal in respective media. When k pieces of media are simultaneously played back, a sound being heard has an amplitude of 1 (which is a unit amplitude). In order to allow sound at the peak amplitude as well as at the unit amplitude to be easily discriminated by listener, it is preferable that a difference of volume between the sounds to be discriminated is equal to or less than approximately 20 dB. In other words, it is preferable that the peak amplitude is equal to or less than 10 times the unit amplitude (p≦10). According to the theorem 1, increasing the value of the p makes the present scheme more secure to a collusion, it is thus preferable that p=10.

Setup of k

According to the theorem, a probability that s sound signal can be identified as either it is a decoy sound or a target sound is a sum of values of a binomial distribution as follows:

$${\sum }_{i = k - q}^{k / 2} {{}_{k}^{}{C}{}_{i}^{} ( \frac{1}{{p}^{2}} )}^{i} {( 1 - \frac{1}{{p}^{2}} )}^{k - i} = {\sum }_{i = k - q}^{k / 2} B ( i ; k , 1 / {p}^{2} )$$

An upper limit is obtained as a function of k and q by approximating this sum of values of a binomial distribution to that of standard normal distribution as described below.

Lemma 2 (Approximation of the Sum of Values of a Binomial Distribution)

If n is sufficiently large to the extent that the binomial distribution can be approximated to a normal distribution, the sum

$${\sum }_{X = Xo}^{n} B ( X ; n , p )$$

of values of the binomial distribution B(X; n, p) can be approximated as

$$Pr [ Z \geq Zo ] = \{ \begin{matrix}\frac{1}{2} - Pr [ 0 \leq Z \leq {Z}_{0} ] & ( if {X}_{0} \geq E ( X ) ) \\ \frac{1}{2} + Pr [ 0 \leq Z \leq - {Z}_{0} ] & ( if {X}_{0} \geq E ( X ) )\end{matrix}$$

where z and z₀ are variables of the standard normal distribution corresponding to x and x₀, respectively and are represented as follows:

$$\begin{matrix}\begin{matrix}Z = \frac{X - np}{\sqrt{npq}} & ( q = 1 - p )\end{matrix} \\ {Z}_{0} = \frac{{X}_{0} - np}{\sqrt{npq}}\end{matrix}$$

In addition, the standard normal distribution (n,1) is a distribution as follows:

$$N ( 0 , 1 ) = \frac{1}{\sqrt{2 π}} {ⅇ}^{- \frac{{z}^{2}}{2}}$$

Theorem 2 (an Upper Limit of a Probability that there Exist a Distribution in which a Sound can be Identified as Either a Target Sound or a Decoy Sound)

Supposing that number of all media is k and there is q person who are in collusion, an upper bound e, that a distribution/layout, in which a sound can be identified as wither a target sound or a decoy sound, is generated, obtained as

$$ɛ = \{ \begin{matrix}\frac{1}{2} - Pr [ 0 \leq Z \leq {Z}_{0} ] & ( if k / 2 - 1 < q \leq ( 1 - 1 / {p}^{2} ) k ) \\ \frac{1}{2} - Pr [ 0 \leq Z \leq - {Z}_{0} ] & ( if ( 1 - 1 / {p}^{2} ) k \leq q \leq k - 1 )\end{matrix}$$

where

$${Z}_{0} = \frac{{p}^{2} ( k - q ) - k}{\sqrt{k ( {p}^{2} - 1 )}}$$

Proof

The binomial distribution B(X;n,p) of the lemma will be applied to the binomial distribution b(I;k,1/p²) obtained by the proposed technique as below. To that end several variables are transformed into as follows:
[p→1/p², q→1−1/p², n→k, X₀→k−q, X→i]

Zₒ is transformed based upon this transformation as follows:

$${Z}_{0} = \frac{( k - q ) - k ( 1 / {p}^{2} )}{\sqrt{k ( 1 / {p}^{2} ) ( 1 - 1 / {p}^{2} )}} = \frac{{p}^{2} ( k - q ) - k}{\sqrt{k ( {p}^{2} - 1 )}} .$$

A probability,

$${\sum }_{i = k - q}^{k / 2} B ( i ; k , 1 / {p}^{2} ) ,$$

that there exist a distribution in which a sound can be identified as either a target sound or a decoy sound, is obtained as

$${\sum }_{i = k - q}^{k / 2} B ( i ; k , 1 / {p}^{2} ) < {\sum }_{i = k - q}^{k} B ( i ; k , 1 / {p}^{2} ) \approx Pr [ X \geq {X}_{0} ] = Pr [ Z \geq {Z}_{0} ]$$

Therefore, the upper limit ε is given by

$$ɛ = Pr [ Z \geq {Z}_{0} ]$$

$$\{ \begin{matrix}\frac{1}{2} - Pr [ 0 \leq Z \leq \frac{{p}^{2} ( k - q ) - k}{\sqrt{k ( {p}^{2} - 1 )}} ] \\ \frac{1}{2} + Pr [ 0 \leq Z \leq - \frac{{p}^{2} ( k - p ) - k}{\sqrt{k ( {p}^{2} - 1 )}} ]\end{matrix} \begin{matrix}( if k / 2 - 1 < q \leq ( 1 - 1 / {p}^{2} ) ) \\ ( if ( 1 - 1 / {p}^{2} ) k \leq q \leq k - 1 )\end{matrix}$$

### EXAMPLE 2

### Determination of Number of Media Based on the Upper Limit Value

It is assumed that p=10. It is further assumed that even if 0.975 k peoples of k persons (i.e., is number of all media), to which the media are distributed, collude with each other, it is desired that a probability that there exist a distribution in which a sound can be identified as either a target sound or a decoy sound is equal to or less than 10⁻³. In such a condition, possible values of the k will be obtained as below.

Substituting p=10, q=0.975 k, and ε≦10⁻³ into the formula of the theorem 2 gives as follows:

$$ɛ \leq {10}^{- 3}$$

$$\frac{1}{2} - {Pr [ 0 \leq Z \leq \frac{{p}^{2} ( k - q - k )}{\sqrt{k ( {p}^{2} - 1 )}} ]}^{ɛ} \leq {10}^{- 3} \\ Pr [ 0 \leq z \leq \frac{100 ( k - 0 k .975 k ) - k}{\sqrt{k ( 100 - 1 )}} ] \geq \frac{1}{2} - {10}^{- 3} \\ Pr [ 0 \leq z \leq \frac{1.5}{\sqrt{99}} \sqrt{k} ] \geq 0.499$$

According to a cumulative standard normal distribution table, a range of Z₀ that an area from origin to Z₀ is equal to or more than 0.499 is obtained as Z₀≧3.08. Accordingly, k is given by

$$\frac{1.5}{\sqrt{99}} = \sqrt{k} \geq 3.08$$

k≦418

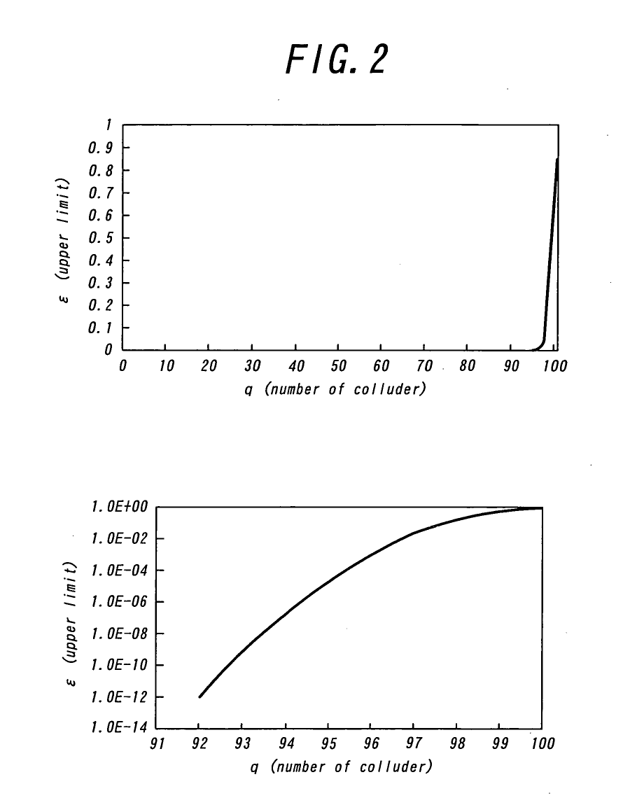

Supposing p=10 (p is an upper limit of an amplitude of both respective sound signals and a sound signal in respective media), FIG. 2-4 shows several graphs in which the data is plotted in conditions such that one of parameters ε, k, and q is fixed, wherein ε is an upper limit or bound of a probability that a sound be identified as either a target sound or a decoy sound, k is number of those to which media are distributed, and q is number of those who are in collusion.

FIG. 2 is a graph illustrating relationship between q and ε, when the number of colluder k is fixed to 100 (i.e., k=100 and p=10). As shown in FIG. 2, for example, it is recognized that, if exceeding around 90% (that is, 90 of 100 persons are in collusion) of the colluder ratio, the upper bound sharply rises.

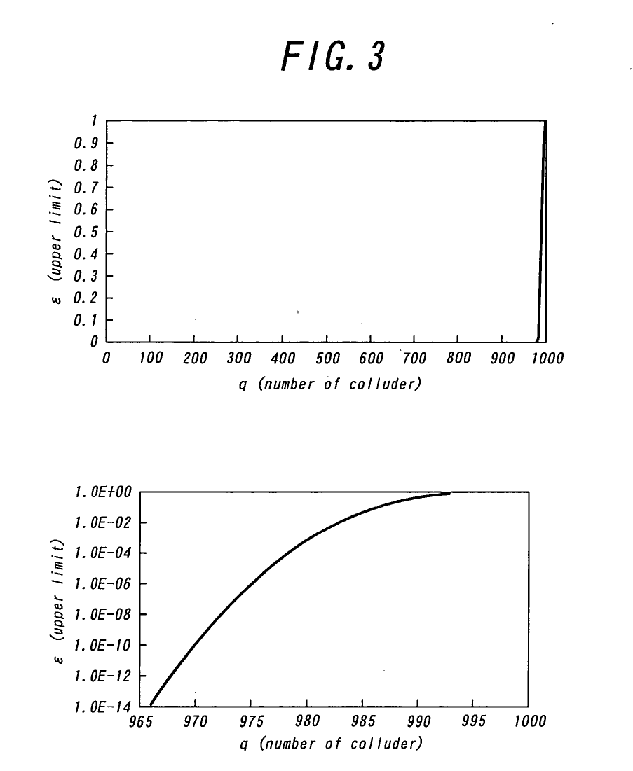

FIG. 3 is a graph depicting relationship between q and ε, when the number of colluder k (those who collude with each other) is fixed to 1000 (i.e., k=1000 and p=10). As shown in FIG. 3, for example, it is recognized that, if exceeding around 96% (that is, 960 of 1000 persons are in collusion) of the colluder ratio, the upper bound sharply rises.

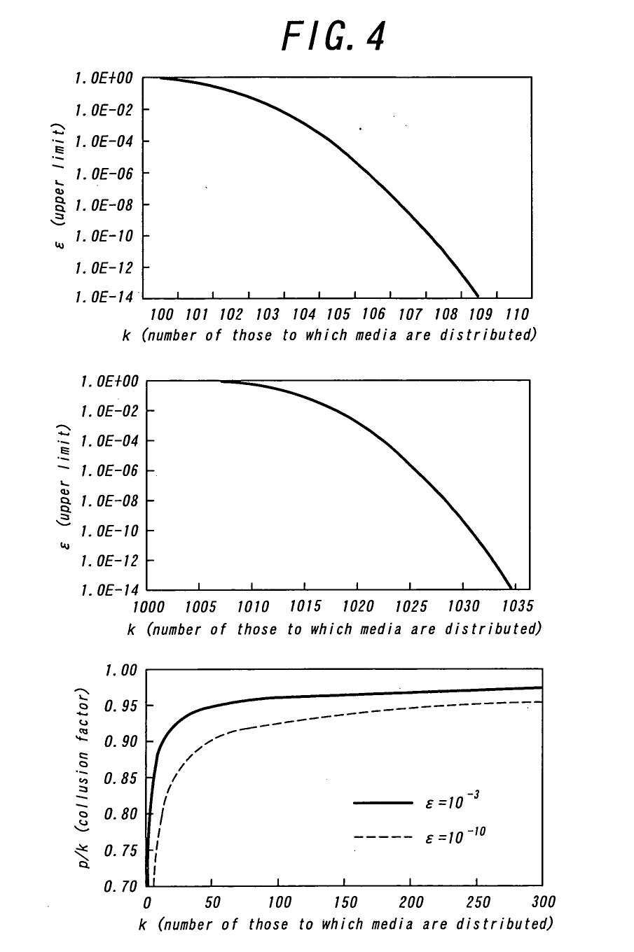

FIG. 4 includes 3 graphs. Its upper part is a graph representing relationship between k and ε when the number of colluder k is fixed to 100 (i.e., k=100, and p=10). Its middle part is a graph illustrating relationship between k and ε when the number of colluder k is fixed to 1000 (i.e., k=1000, and p=10). Its bottom part is a graph showing relationships between k and q/k when ε is fixed to 10⁻³ and 10⁻¹⁰ (ε=10⁻³ and ε=10⁻¹⁰). It can be calculated that how many media should be set up for k by using these graphs (or calculation technique as described in the example 2) for getting a desired value of the upper bound E in a certain anticipated colluder ratio.

As described above, the present invention is a newly technique for distributing/sharing secret information using human audio properties for decoding, unlike any known sound distributing/sharing techniques. In the present invention, as shown in FIGS. 2, 3, and 4 (in particular FIG. 4), when number k (i.e., number of media) of those to which media are distributed is set to equal or exceed 50 persons, a considerable degree of security can be assured. It is further preferable that k is set to equal or larger than 100, more robust secret distribution to collusion can be realized by this configuration.

### INDUSTRIAL APPLICABILITY

As described above, the present invention is a technique for distributing/sharing secret information using audio, more specifically is a technique for distributing/sharing secret information using audio, wherein the secret information is information being required to identify which sound is a target sound from several sound source, the secret information is distributed to several persons to be shared and stored by them, and the distributed information are collected to be restored. As described above, the present invention has an advantage that signal processing can considerably be reduced in both a generation process of distribution information and a decoding/restoration process of the secret information from the distribution information by using human audio perception abilities of a direction perception regarding sound-image localization. In this way, the present invention can be utilized for many fields using sounds such as a music industry, radio industry, or movie industry, because the present invention can utilize sound signals.

While the present invention has been described with respect to some embodiments and drawings, it is to be understood that the present invention is not limited to the above-described embodiments, and modifications and drawings, various changes and modifications may be made therein, and all such changes and modifications are considered to fall within the scope of the invention as defined by the appended claims. For example, those skilled in the art can readily configure a more safely technique capable of containing of more secret information by combining the technique (in which secret is a sound signal in its self) in the “Nonbinary Audio Cryptography” with the present invention from this disclosure.

1. An apparatus utilizing sound-image localization for distributing audio secret information, comprising:
a first signal processor for distributing at lest one target sound as secret information into a plurality of stereo media, wherein the distribution is performed such that the sound-image of the target is shifted from the center position of the head when said plurality of stereo media are simultaneously played to be heard in a binaural manner;
a second signal processor for distributing a plurality of decoy sounds as disturbing information into the said plurality of stereo media, wherein the distribution is performed such that the sound-image of the decoy sounds is localized to the center position of the head when said plurality of stereo media are simultaneously played to be heard in a binaural manner.

2. The apparatus according to claim 1, wherein said first and second signal processors control whether or not that the sound-image is localized to the center position of the head by adjusting volumes of right and left channels of the stereo media, respectively.

3. The apparatus according to claim 1, wherein the sum, n, of the number of said target sound and the number of said decoy sounds is equal to or less than 6.

4. The apparatus according to claim 1, wherein the peak amplitude, p, of one side of one sound signal of said stereo media is equal to or less than about 10.

5. The apparatus according to claim 1, further comprising calculating means for calculating the number of said stereo media from a desired safety factor and/or an anticipated colluder factor.

6. A method utilizing sound-image localization for distributing audio secret information, comprising the steps of:
a first step for distributing at lest one target sound as secret information into a plurality of stereo media, wherein the distribution is performed such that the sound-image of the target is shifted from the center position of the head when said plurality of stereo media are simultaneously played to be heard in a binaural manner;
a second step for distributing a plurality of decoy sounds as disturbing information into the said plurality of stereo media, wherein the distribution is performed such that the sound-image of the decoy sounds is localized to the center position of the head when said plurality of stereo media are simultaneously played to be heard in a binaural manner.

7. The method according to claim 6, wherein said first and second steps control whether or not that the sound-image is localized to the center position of the head by adjusting volumes of right and left channels of the stereo media, respectively.

8. The method according to claim 6, wherein the sum, n, of the number of said target sound and the number of said decoy sounds is equal to or less than 6.

9. The method according to claim 6, wherein the peak amplitude, p, of one side of one sound signal of said stereo media is equal to or less than about 10.

10. The method according to claim 6, further comprising calculating the number of said stereo media from a desired safety factor and/or an anticipated colluder factor using computing means.

11. A program for executing a method utilizing sound-image localization for distributing audio secret information, said program comprising the steps of:
a first step for distributing at lest one target sound as secret information into a plurality of stereo media, wherein the distribution is performed such that the sound-image of the target is shifted from the center position of the head when said plurality of stereo media are simultaneously played to be heard in a binaural manner;
a second step for distributing a plurality of decoy sounds as disturbing information into the said plurality of stereo media, wherein the distribution is performed such that the sound-image of the decoy sounds is localized to the center position of the head when said plurality of stereo media are simultaneously played to be heard in a binaural manner.

12. The program according to claim 11, wherein said first and second steps control whether or not that the sound-image is localized to the center position of the head by adjusting volumes of right and left channels of the stereo media, respectively.

13. The program according to claim 11, wherein the sum, n, of the number of said target sound and the number of said decoy sounds is equal to or less than 6.

14. The program according to claim 11, wherein the peak amplitude, p, of one side of one sound signal of said stereo media is equal to or less than about 10.

15. The program according to claim 11, further comprising calculating the number of said stereo media from a desired safety factor and/or an anticipated colluder factor using computing means.
